(19) United States
(12) Patent Application Publication
(10) Pub. No.: US 2014/0153121 A1
(43) Pub. Date: Jun. 5, 2014

(54) Device and Method to Repel Flying Pests from Unwanted Areas

(71) Applicant: Toby W. Savage, Bradford, OH (US)

(72) Inventor: Toby W. Savage, Bradford, OH (US)

(21) Appl. No.: 13/692,322

(22) Filed: Dec. 3, 2012

(51) Int. Cl. A01M 29/08

(52) U.S. Cl. CPC A01M 29/08
USPC 359/850

(57) ABSTRACT

The present invention provides a device and method to repel flying pests from unwanted areas. The device comprises an optically clear tube containing a clear liquid having suspended therein a plurality of reflective metal reflective flakes. The contents of the tube are tightly sealed with an end cap at either end of the tube, and the end caps have a string attached thereto to allow a user to hang the tube from a support. Incoming light rays which hit the plurality of reflective flakes are reflected to produce outgoing light rays. Flying pests located in the vicinity are attracted to the outgoing reflected light rays and fly away from the device in substantially the same path and the same direction as one or more of the outgoing reflected light rays, and thus away from the area where they are unwanted.

### FIELD OF THE INVENTION

The present invention relates to pest repellants and, in particular, to a non-chemical, long-lasting, human, pet and environmentally friendly device and method to repel flying pests.

### BACKGROUND OF THE INVENTION

Flying pests, such as mosquitoes, wasps, flies, bees and the like, almost always are unwelcome guests in one's home, workplace, restaurants and outdoor recreational areas, especially now with the increase in infection from mosquito-borne West Nile virus. There are many pest repellants on the market such as aerosol sprays, citronella candles, various types of fly paper and electric “zappers.” A large disadvantage of using electric zappers is lack of sanitation, as there are bound to be tiny particles of dead insects in areas where the zapper is used, which is totally unacceptable in food handling areas. Most of the other pest repellants contain chemicals of one kind or another to effectuate their action, which chemicals dissipate during use, and thus need to be replaced periodically. More importantly, many of the chemicals contained in currently available pest repellants pose some degree of danger to humans, pets and the environment.

A need exists, therefore, for a long-lasting, economical, non-chemical, environmentally friendly pest repellant that effectively repels flying pests from unwanted areas.

### SUMMARY OF THE INVENTION

The present invention fulfills this need by providing a non-chemical, long-lasting, economical and environmentally friendly device and method for repelling flying pests away from areas where they are unwanted.

In particular, the present invention provides a device to repel flying pests from an area where they are unwanted, comprised of an optically clear tube having an outer surface, a first end and a second end, in which the first end and the second end each having an opening therein defining an interior space in the tube. The tube contains an optically clear liquid, in which a plurality of reflective flakes is suspended therein. Each end of the tube is sealed with an end cap. A string is attached to the first end cap and to the second end cap so that a user may hang the device from a support located in an area where flying pests are not wanted. Incoming light rays that hit the plurality of reflective flakes suspended in the liquid are reflected off of the plurality of reflective flakes to produce outgoing light rays. Flying pests located in the vicinity of the tube are attracted to the outgoing light rays and fly away from the unwanted areas in substantially the same path and the same direction as one or more of the outgoing light rays.

The present invention also provides a method for repelling flying pests from an area where they are unwanted. The method comprises the steps of hanging the above-described device from a support located in an area where flying pests are not wanted, having incoming light rays hit the plurality of reflective flakes suspended in the liquid of the device; emitting outgoing light rays from the interior space of the tube, said emission caused by reflection of the incoming light rays off of the plurality of reflective flakes suspended in the liquid; and attracting any flying pests in the unwanted area towards the outgoing light rays, resulting in the flying pests flying away from the tube in a path and a direction that is substantially the same path and the same direction as one or more of the reflected outgoing light rays.

### BRIEF DESCRIPTION OF THE DRAWINGS

A fuller understanding of the invention can be gained from the following description when read in conjunction with the accompanying drawings in which:

FIG. 1 is an isometric view of the device in accordance with the embodiments of the invention;

FIG. 2 is a horizontal side view of the device in accordance with the embodiments of the invention; and

FIG. 3 is a vertical side view of the device in accordance with the embodiments of the invention.

### DETAILED DESCRIPTION OF THE INVENTION

A complete understanding of the present invention will be obtained from the following description taken in connection with the accompanying drawing figures, wherein like reference characters identify like parts throughout.

As used herein, the term “reflective flake(s)” is interchangeable with the terms “shaving(s)” or “particle(s).”

As used herein the term “reflective flake” is defined as a flake that reflects light from its surface.

As used herein, the term “flying pest(s)” is interchangeable with the term “flying insect(s)”.

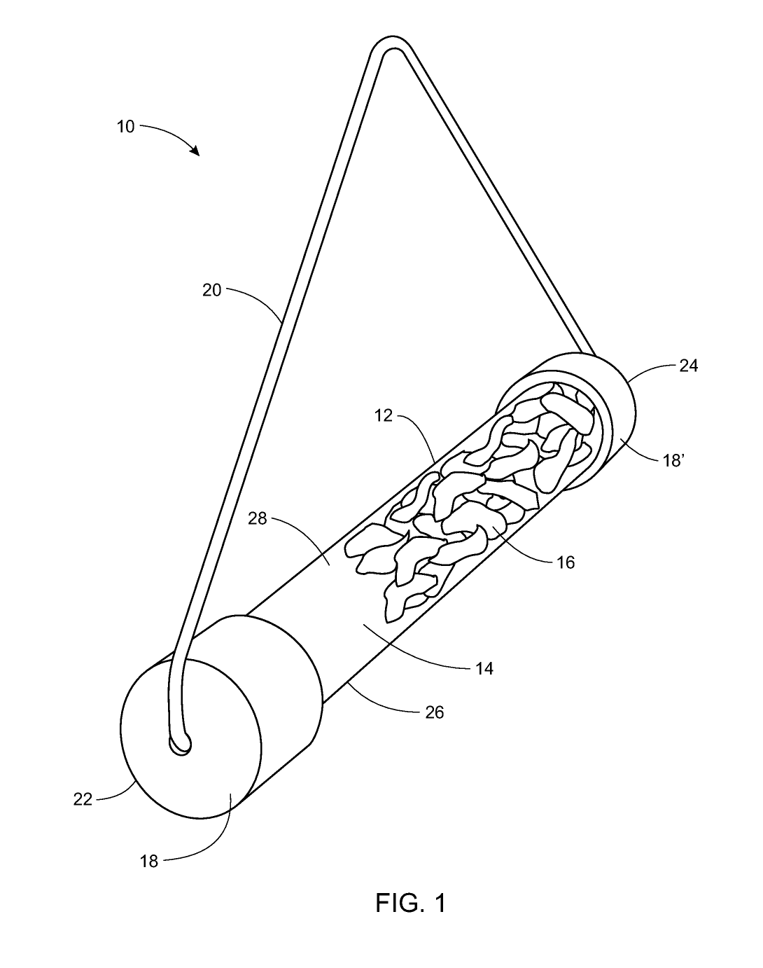

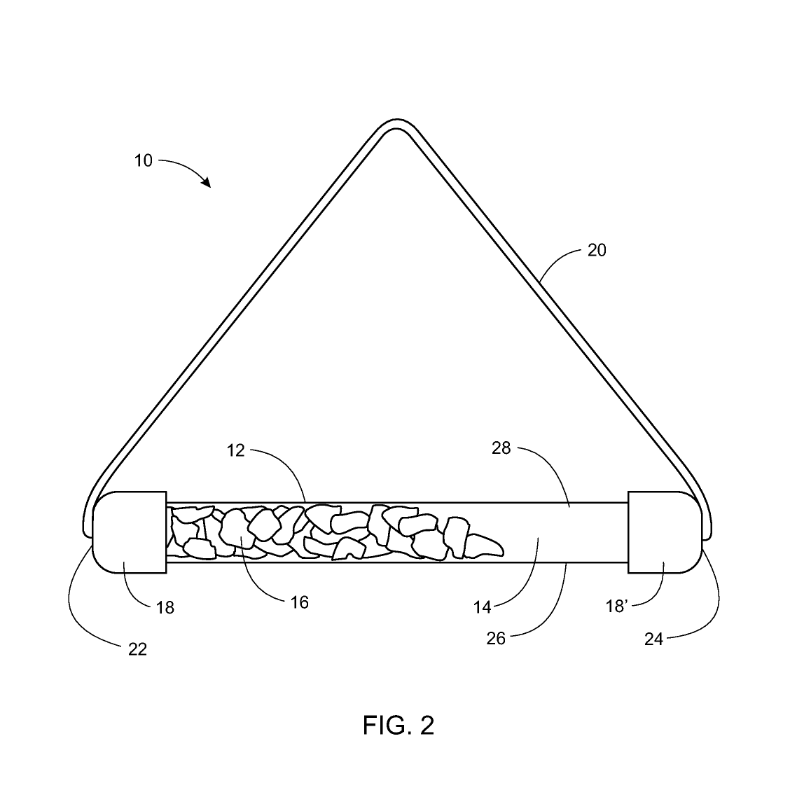

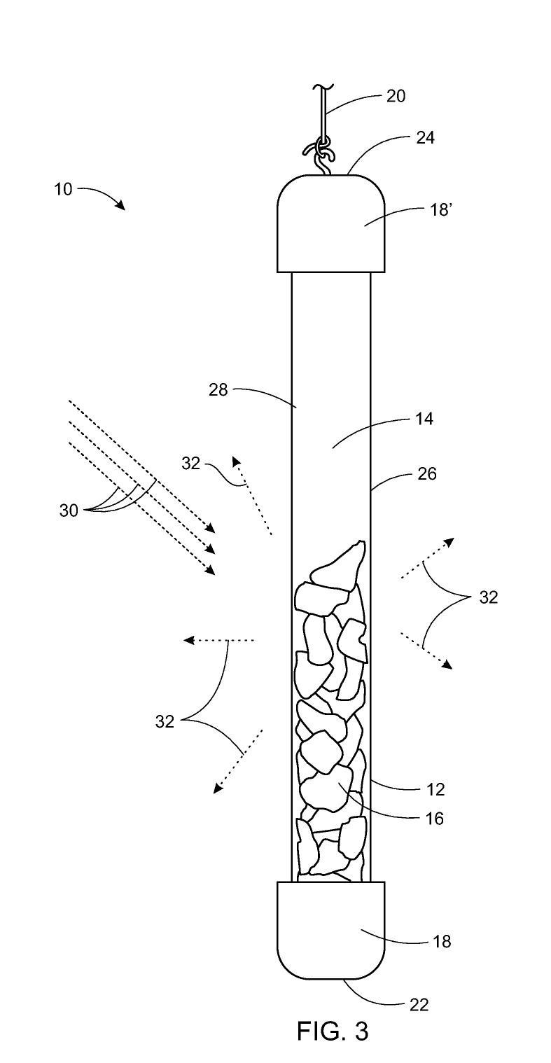

In one embodiment, the present invention provides a device to repel flying pests from an area where they are unwanted. As shown in FIGS. 1-3, the device 10 is comprised of an optically clear tube 12 having an outer surface 26, a first end 22 and a second end 24, in which the first end 22 and the second end 24 each has an opening therein (not shown) defining an interior space 28 in the tube 12. The tube 12 contains an optically clear liquid 14, in which a plurality of reflective flakes 16 is suspended therein. A first end cap 18 and a second end cap 18′ fit over the first end 22 and the second end 24 of the tube 12, respectively, to tightly seal the openings of the tube 12. A string 20 is attached to the first end cap 18 and to the second end cap 18′, so that a user can hang the device 12 from a support (not shown) that is located in an area where flying pests are not wanted. As shown in FIG. 3, incoming light rays 30 that hit the plurality of reflective flakes 16 suspended in the liquid 14 are reflected off of the plurality of reflective flakes 16 to produce outgoing light rays 32. Flying pests located in the vicinity of the tube 12 are attracted to the outgoing light rays 32 and fly in substantially the same path and the same direction as one or more of the reflected outgoing light rays 32.

In another embodiment, the present invention provides a method for repelling flying pests from an area where they are unwanted. The method is comprised of the steps of hanging the above-described device from a support located in an area where flying pests are not wanted, having incoming light rays hit the plurality of reflective flakes suspended in the liquid of the device; emitting outgoing light rays from the interior space of the tube, said emission caused by reflecting the incoming light rays off of the plurality of reflective flakes suspended in the liquid; and attracting any flying pests in the unwanted area towards the outgoing light rays, resulting in the flying pests flying away from the tube in a path and a direction that is substantially the same path and the same direction as one or more of the reflected outgoing light rays.

In accordance with the device and method of the invention, the length of the tube is about 4.0 inches to about 20.0 inches, and the cross-sectional area of the tube is about 0.25 inches to about 2.0 inches. In one embodiment, the length of the tube is about 5.0 inches, and the cross-sectional area of the tube is about 0.5 inches.

In accordance with the invention, the length of the string may be adjustable and is about 6.0 inches to about 36.0 inches in length. In an embodiment, the length of the string is about 14.0 inches. The end of the string can attach to each end cap in a variety of ways, such as, without limitation, being glued to end cap with adhesive, or secured by a small hook located on the outer surface of the end cap.

Suitable optically clear liquids for use in the device and method of the invention include, without limitation, distilled water, deionized water, alcohol or combinations thereof.

Suitable reflective flakes for use in the device and method of the invention include, without limitation, metal shavings capable of reflecting light such as shavings from copper, aluminum, iron or combinations thereof.

In an embodiment, about one-half to about five-sixths of the liquid contained in the interior space of the tube is filled with the plurality of reflective flakes. In another embodiment, about three-fourths of the liquid contained in the interior space of the tube is filled with the plurality of reflective flakes.

In accordance with the invention, the interior space of the tube containing the liquid and the plurality of reflective flakes is sterilized after tightly sealing the openings of the tube with the end caps in order to prevent microbial contamination of the interior space of the tube. Suitable sterilization techniques include, without limitation, steam heat autoclaving or ultraviolet light radiation.

Suitable materials that may be used to fabricate the tube of the invention include, without limitation, plastic acrylics and the like, so long as the materials are optically clear.

Suitable materials that may be used to fabricate the end caps of the invention include, without limitation, plastic or metal.

In an embodiment, the tube is cylindrically shaped.

It is common knowledge that flying pests are attracted to light. It is believed, without being bound by the theory, that flying pests are attracted to the device of the invention as incoming light rays impinge on the device. When the incoming light rays hit the plurality of reflective flakes in the interior space of the tube, the reflective flakes concentrate and intensify the light rays, and thus the flying pests are more attracted to the more intense, outgoing light rays, resulting in the flying pests flying away from the device in substantially the same path and the same direction as one or more of the outgoing light rays and thus away from the unwanted area.

The invention envisions that the support to which the device may be hung can include, without limitation, doorways, indoor or outdoor furniture, lamp posts, or any other support structure located in an area where flying pests are unwanted. When hung on a support, the string allows for rotational movement of the device and the plurality of reflective flakes therein, facilitating reflection of light by the plurality of reflective flakes, producing a “light show” that further attracts flying pests.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A device to repel flying pests from an area where they are unwanted, comprising:
an optically clear tube having an outer surface, a first end and a second end, said first end and said second end each having an opening therein defining an interior space in the tube;
an optically clear liquid contained in the interior space of the tube, said liquid containing a plurality of reflective flakes suspended therein;
a first end cap that seals the opening in the first end of the tube and a second end cap that seals the opening in the second end of the tube; and
a string having a first end and a second end, said first end attached to the first end cap and said second end attached to the second end cap, said string allowing a user to hang the device from a support located in an area where flying pests are not wanted, wherein incoming light rays hit the plurality of reflective flakes suspended in the liquid, said incoming light rays being reflected off of the plurality of reflective flakes to produce outgoing light rays which attracts any flying pests in the unwanted area towards the outgoing light rays, resulting in the flying pests flying away from the tube in a path and a direction that is substantially the same path and the same direction as one or more of the reflected outgoing light rays.

2. The device of claim 1, wherein the length of the tube is about 4.0 inches to about 20.0 inches and the cross-sectional area of the tube is about 0.25 inches to about 2.0 inches.

3. The device of claim 2, wherein the length of the tube is about 5.0 inches and the cross-sectional area of the tube is about 0.5 inches.

4. The device claim 1, wherein the length of the string is about 6.0 inches to about 36.0 inches.

5. The device of claim 4, wherein the length of the string is about 14.0 inches.

6. The device of claim 1, wherein the optically clear liquid contained in the interior space of the tube is selected from the group consisting of distilled water, deionized water, alcohol and combinations thereof.

7. The device of claim 1, wherein the reflective flakes are metal shavings capable of reflecting light selected from the group consisting of copper, aluminum, iron and combinations thereof.

8. The device of claim 1, wherein the interior space of the tube containing the liquid and the plurality of reflective flakes therein are sterilized after the tube is sealed in order to prevent microbial contamination of the interior space of the tube.

9. The device of claim 1, wherein the tube is made of clear plastic acrylic.

10. The device of claim 1, wherein the tube is cylindrical in shape.

11. A method for repelling flying pests from an area where they are unwanted, comprising the steps of:
hanging an optically clear tube from a support located in an area where flying pests are not wanted, wherein said tube has an outer surface, a first end and a second end, said first end and said second end each having an opening therein defining an interior space in the tube; an optically clear liquid contained in the interior space of the tube, said liquid containing a plurality of reflective flakes suspended therein; a first end cap that seals the opening in the first end of the tube and a second end cap that seals the opening in the second end of the tube; and a string having a first end and a second end, said first end of the string attaching to the first end cap and said second end of the string attaching to the second end cap, said string allowing a user to hang the device from the support;
having incoming light rays hit the plurality of reflective flakes suspended in the liquid;
emitting outgoing light rays from the interior space of the tube, said emission caused by reflecting the incoming light rays off of the plurality of reflective flakes; and
and attracting any flying pests in the unwanted area towards the outgoing light rays, resulting in the flying pests to fly away from the tube in a path and a direction that is substantially the same path and the same direction as one or more of the reflected outgoing light rays.

12. The method of claim 11, wherein the length of the tube is about 4.0 inches to about 20.0 inches and the cross-sectional area of the tube is about 0.25 inches to about 2.0 inches.

13. The method of claim 12, wherein the length of the tube is about 5.0 inches and the cross-sectional area of the tube is about 0.5 inches.

14. The method of claim 11, wherein the length of the string is about 6.0 inches to about 36.0 inches.

15. The method of claim 14, wherein the length of the string is about 14.0 inches.

16. The method of claim 11, wherein the optically clear liquid contained in the interior space of the tube is selected from the group consisting of distilled water, deionized water, alcohol and combinations thereof.

17. The method of claim 11, wherein the reflective flakes are metal shavings capable of reflecting light selected from the group consisting of copper, aluminum, iron and combinations thereof.

18. The method of claim 11, wherein the interior space of the tube containing the liquid and the plurality of reflective flakes therein are sterilized after the tube is sealed in order to prevent microbial contamination of the interior space of the tube.

19. The method of claim 11, wherein the tube is made of clear plastic acrylic.

20. The method of claim 11, wherein the tube is cylindrical in shape.
